(19) United States
(12) Patent Application Publication
(10) Pub. No.: US 2011/0298372 A1
(43) Pub. Date: Dec. 8, 2011

(54) LED Lamp

(75) Inventor: Jian He, Sichuan (CN)

(73) Assignees: Bestone Global Electronics Inc., Markham (CA); Jian He, Sichuan (CN)

(21) Appl. No.: 12/796,027

(22) Filed: Jun. 8, 2010

(51) Int. Cl. H01J 13/46

(52) U.S. Cl. 315/35

(57) ABSTRACT

The invention discloses a LED lamp, including: a lamp body has illuminating surface and reflective panel, wherein the reflective panel reflects light then transmits by illuminating surface, both sides of reflective panel have axial strip-shaped notch while both ends of lamp body have lamp holder; two LED luminous components, cooperatively installed inside the strip-shaped notch of lamp body and the illuminating surface turns to reflective panel; a drive circuit installed inside lamp holder, and electrically connects with luminous components and illuminates LED luminous components. The light from LED light source of the invention transmits from illuminating surface after the diffuse reflection from reflective panel and multiple refractions from solid lamp body, increasing light-emitting area, and lights are bright, mild and even; with effectual lighting, lower power consumption, longer life-span and good for eyes, the invention is applicable widely to house, office, market, carriage with great economic and social benefit.

### TECHNICAL FIELD

The invention relates to a light emitting diode (hereinafter referred to in the specification and claims as “LED”) lamp, especially refers to a LED lamp which is able to emit a bright, even and mild light by reflection and refraction of the LED light source from lamp body

### BACKGROUND ART

Currently, we need to consume a large amount of energy for daily lighting; therefore the LED lamp is gradually replacing the traditional fluorescent lamps and become the new lighting for its low energy consumption, effectual in lighting and longer life span. The common LED lamps typically includes hollow translucent tube, lamp holder, drive circuits and LED luminous components, wherein the LED luminous body evenly installed on the printed circuit board (hereinafter referred to as “PCB”) and located inside the hollow translucent tube, by the drive circuits to drive the LED to achieve the lighting purpose. However, the LED lamp may not provide normal lighting for the lack of bright, or easier to hurt people's eyes for the high brightness.

### CONTENTS OF THE INVENTION

To overcome the shortage of the current technology, this invention is to provide a LED lamp which is able to emit a bright, even and mild light by reflection of LED light source from the lamp body and refraction from the illuminating surface, which assures the brightness of the lighting, and also will not dazzle or hurt eyes.

For achieving the objective above, this invention adopts the following technical solutions:

A LED lamp, comprising:

a lamp body, wherein the lamp body has an illuminating surface and a reflective panel, while the reflective panel reflects the light and then transmits by the illuminating surface, and on the both sides of the reflective panel separately have axial strip shaped notch;

two luminous components, wherein the luminous components includes a strip shaped PCB (printed circuit board) and several LEDs as linear arrangement in the strip shaped PCB, which the two luminous components separately and cooperatively installed inside the strip shaped notch of the lamp body and the illuminating surface turn towards the reflective panel of the lamp body;

a drive circuit which installed inside the lamp holder and has electrical connection with the luminous components, and drive the LED luminous components to illuminate.

The foresaid lamp body is a solid translucent lamp, wherein both the illuminating surface and the reflective panel are concentric circular arc face and the axial strip shaped notches are separately installed in the fan-shaped section of the both sides of the reflective panel.

The foresaid reflective panel is a circular arc face with 90 degree

The radius of the foresaid reflective panel is smaller than the radius of the illuminating surface; the outboard of the strip shaped notches in the both sides of the reflective panel separately have card slot; a seal housing joints in the rear of the reflective panel by the card slot in the both sides of the reflective panel, and the thickness is the difference value of the radius of illuminating surface and the radius of the reflective panel.

The foresaid reflective panel is the reflecting coating in the lamp wall.

The foresaid lamp body is made by acrylic material.

The foresaid lamp holder is moveable lamp holder, wherein the moveable lamp holder comprising:

a permanent joint, wherein one end is fixedly connected with the lamp body, while the other end has a locating hole;

an adapter, wherein one end is moveably connected with the permanent joint and has a locating convexity in coordination with the locating hole;

a flexible fastening device to connect the adapter and the permanent joint;

a gland, wherein one end of the gland is fixedly connected with the adapter and the other end has lamp binding post.

The foresaid moveable lamp holder comprising:

a permanent joint, wherein one end is fixedly connected with the lamp body, while the other end has a central through hole; along with the periphery of the central through hole has eight locating holes, wherein the eight locating holes are evenly distributed in the circular arc that is concentric with the central through hole; between the central through hole and the locating hole has two slots, wherein the slots are central symmetric and between both ends of the two slots has locating hole;

an adapter, wherein one end is moveably connected with the permanent joint while the other end is fixedly connected with the gland; the connecting end of the permanent joint has a locating convexity in coordination with the eight locating holes of the permanent joint and a whirling limited post in coordination with the slot, while the end face has multistep central through hole to locate the reset spring;

a reset spring is placed inside the multistep central through hole of the adapter;

a connector, wherein one end has a spring button and the other end has a spring plate, while the connector pass through the reset spring and lock joint inside the through hole of the end face of the permanent joint by the central through hole of the adapter.

a gland, wherein one end of the gland is fixedly connected with the adapter and the other end has lamp binding post.

By adopting the above structure, the light from the LED light source of the LED lamp of the invention transmits from the illuminating surface after the diffuse reflection from the reflective panel and multiple refractions from the solid lamp body, which increase the light-emitting area of the lamp, and the lights are bright, mild and even; with an effectual the lighting function, low consumption of power, longer life span and good for people's eye. Furthermore, by using the moveable joint in the both ends of the lamp body, it is convenient to install the LED lamp and the luminous surface is always oriented to the required light angle; the invention could be applicable widely to the house, office, market, carriage and so on which requires for lighting, and it has great economic and social benefit.

### DESCRIPTION OF FIGURES

FIG. 1 is the axial cutaway view of the invention;

FIG. 2 is the radial cutaway view of the invention;

FIG. 3 is the schematic section view of lamp body of the invention;

FIG. 4 is the structure view of the end face of the permanent join of the invention;

FIG. 5 is the A-A cutaway view of the FIG. 4;

FIG. 6 is the structure view of the end face of the adapter of the invention;

FIG. 7 is the B-B cutaway view of the FIG. 6;

FIG. 8 is the structure view of the end face of the gland of the invention;

FIG. 9 is the axial cutaway view of the connector of the invention.

### MODE OF CARRYING OUT THE INVENTION

Further explanation to the invention is stated below combining with the attached figures:

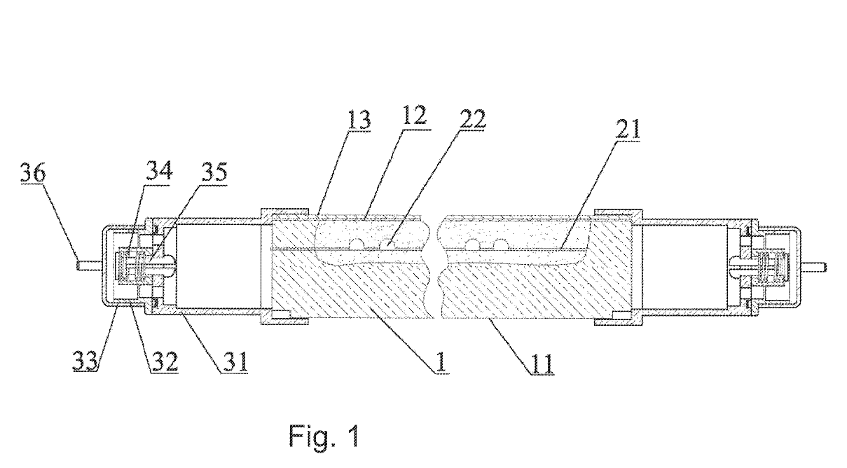

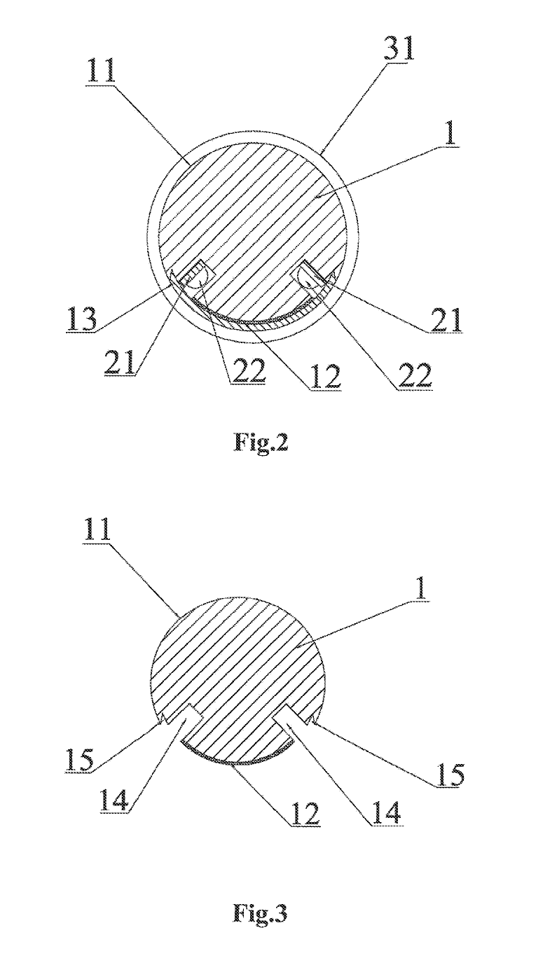

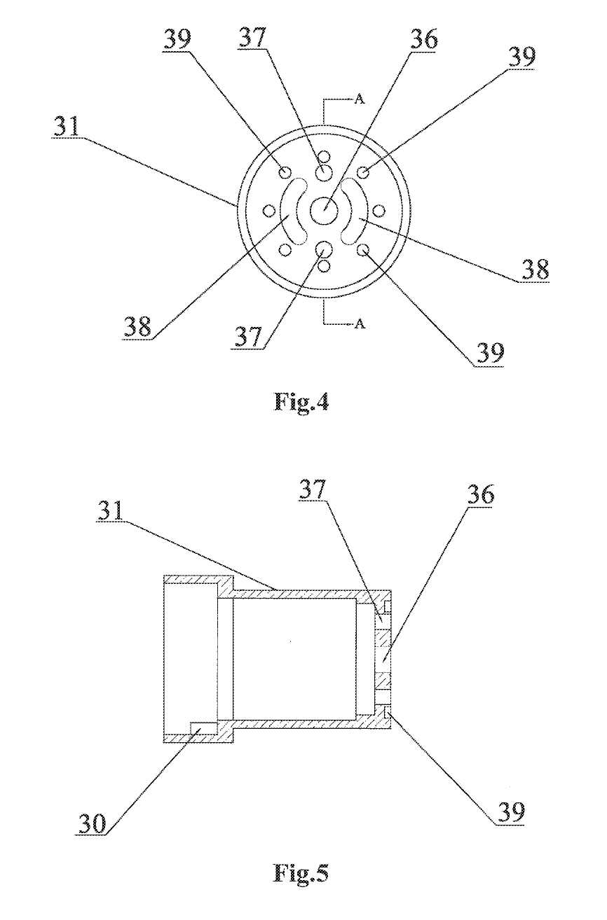

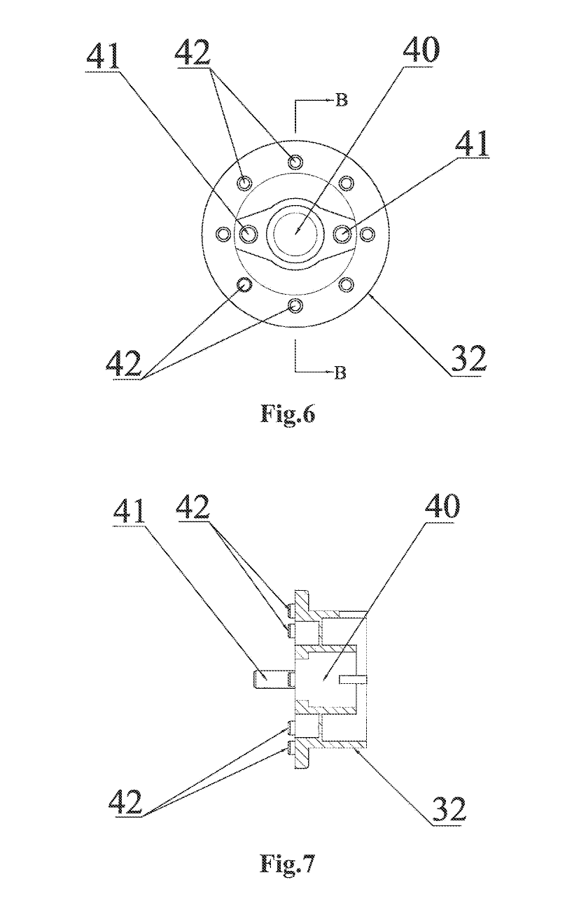

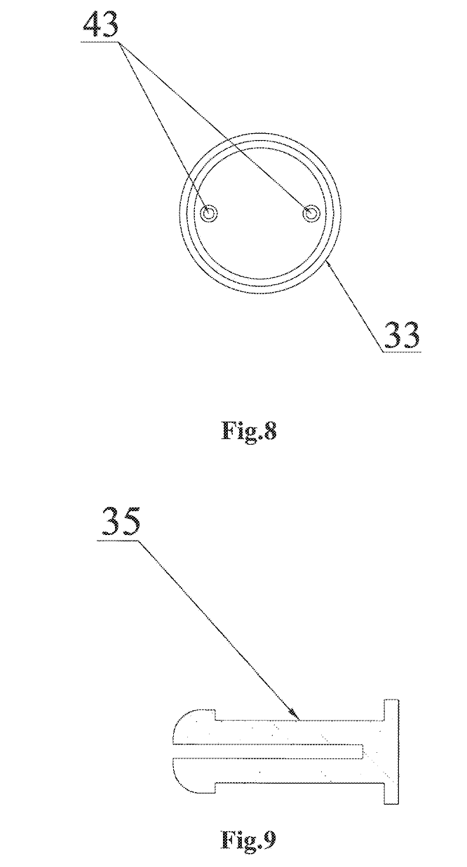

As shown in FIG. 1 to FIG. 9, a LED lamp, including lamp body 1, LED luminous components and lamp holder; the lamp body 1 is made by the solid translucent material such as acrylic with high performance of light transmission. The lamp body has concentric illuminating surface 11 and reflective panel 12 with radius vary in size, while the radius of the illuminating surface 11 is greater than the radius of the reflective panel 12 and occupy nearly three quarters of the radian of the lamp wall; the reflective panel 12 adopts the reflecting coating in the mirror plane in priority with an 90 degree circular arc. On the both sides of the sector of the reflective panel 12 separately has axial strip shaped notch 14, and the outboard of the axial strip shaped notches 14 separately have card slot 15.

The luminous components includes a strip shaped PCB (printed circuit board) 21 and several LEDs 22 in linear arrangement in the strip shaped PCB 21. The luminous components separately installed inside the strip shaped notch 14 and the LED 22 turn towards the reflective panel 12 by the lighting axis that is perpendicular to the angle of the radius of the both side of the reflective panel. The rear of the reflective panel 12 has a seal housing 13, wherein the seal housing 13 fixed on the lamp body 1 by the card slot 15 on both sides of the strip shaped notch 14, and the thickness of the seal housing 13 is the difference value of the radius of illuminating surface 11 and the radius of the reflective panel 12, so that the lamp maintain cylindrical.

In order to easily install of the LED lamp and make the illuminating surface 11 to follow the required lighting angle, both ends of the lamp body 1 has separately fixed two moveable lamp holders, wherein the lamp holder includes permanent joint 31, adapter 32 and gland 33. One end of the permanent joint 31 is fixedly connected with the lamp body 1, while the fixed convexity 30 inside the permanent joint 31 joints inside the notch 14 in the end of the lamp body 1 to assure that the permanent joint 31 will not whirling related to the lamp body 1; the other end of the permanent joint 31 is moveable connected with the adapter 32. The connecting end of the permanent joint 31 and the adapter 32 has central through hole 36, along with the periphery of the central through hole 36 has eight locating holes 39 wherein the eight locating holes 39 are evenly distributed in the circular arc that is concentric with the central through hole 36; between the central through hole 36 and the locating hole 39 has two slots 38, wherein the slots 38 are central symmetric and between both ends of the two slots 38 has locating hole 37; the connecting end of the adapter 32 and the permanent joint 31 has a locating convexity 42 in coordination with the eight locating holes 39 of the permanent joint and a whirling limited post 41 in coordination with the slot 38, while the end face has multistep central through holes 40 to locate the reset spring; One end of the connector 35 has a spring button and the other end has a spring plate, while the connector 35 lock joint inside the central through hole 36 by pass through the reset spring 34, the multistep central through hole 40 of the adapter 32 and the central through hole 36 of the permanent joint 31. The adapter 32 is able to adjust and reset in axial direction with the connector 35, meanwhile it is able to along the axis of the connector 35 and in coordination with the slot 38 and limited post 41 to stop spacing and swirling.

The drive circuits of the LED luminous components locate inside the moveable lamp holder and have an electrical connection with the LED luminous components, and then connect with the external power source by the binding post 43 of the lamp holder gland 33.

What is claimed is:

1. A LED lamp, comprising:
a lamp body, wherein the lamp body has an illuminating surface and a reflective panel, while the reflective panel reflects the light and then transmits by the illuminating surface, and on the both sides of the reflective panel separately have axial strip shaped notch;
two luminous components, wherein the luminous components includes a strip shaped printed circuit board and several LEDs as linear arrangement in the strip shaped printed circuit board, which the two luminous components separately and cooperatively installed inside the strip shaped notch of the lamp body and the illuminating surface turn towards the reflective panel of the lamp body;
a drive circuit which installed inside the lamp holder and has electrical connection with the luminous components, and drive the LED luminous components to illuminate.

2. A LED lamp as set forth in claim 1, characterized in that the foresaid lamp body is a solid translucent lamp, wherein both the illuminating surface and the reflective panel are concentric circular arc face and the axial strip shaped notches are separately installed in the fan-shaped section of the both sides of the reflective panel.

3. A LED lamp as set forth in claim 2, characterized in that the foresaid reflective panel is a circular arc face with 90 degree

4. A LED lamp as set forth in claim 2, characterized in that the radius of the foresaid reflective panel is smaller than the radius of the illuminating surface; the outboard of the strip shaped notches in the both sides of the reflective panel separately have card slot; a seal housing joints in the rear of the reflective panel by the card slot in the both sides of the reflective panel, and the thickness is the difference value of the radius of illuminating surface and the radius of the reflective panel.

5. A LED lamp as set forth in claim 3, characterized in that the radius of the foresaid reflective panel is smaller than the radius of the illuminating surface; the outboard of the strip shaped notches in the both sides of the reflective panel separately have card slot; a seal housing joints in the rear of the reflective panel by the card slot in the both sides of the reflective panel, and the thickness is the difference value of the radius of illuminating surface and the radius of the reflective panel.

6. A LED lamp as set forth in any claim from 1, characterized in that the foresaid reflective panel is the reflecting coating in the lamp wall.

7. A LED lamp as set forth in any claim from 2, characterized in that the foresaid reflective panel is the reflecting coating in the lamp wall.

8. A LED lamp as set forth in any claim from 3, characterized in that the foresaid reflective panel is the reflecting coating in the lamp wall.

9. A LED lamp as set forth in claim 4, characterized in that the foresaid reflective panel is the reflecting coating in the lamp wall.

10. A LED lamp as set forth in claim 5, characterized in that the foresaid reflective panel is the reflecting coating in the lamp wall.

11. A LED lamp as set forth in claim 2, characterized in that the foresaid lamp body is made by acrylic material.

12. A LED lamp as set forth in claim 1, characterized in that the foresaid lamp holder is moveable lamp holder, wherein the moveable lamp holder comprising:
a permanent joint, wherein one end is fixedly connected with the lamp body, while the other end has a locating hole;
an adapter, wherein one end is moveably connected with the permanent joint and has a locating convexity in coordination with the locating hole;
a flexible fastening device to connect the adapter and the permanent joint;
a gland, wherein one end of the gland is fixedly connected with the adapter and the other end has lamp binding post.

13. A LED lamp as set forth in claim 11, characterized in that the foresaid moveable lamp holder comprising:
a permanent joint, wherein one end is fixedly connected with the lamp body, while the other end has a central through hole; along with the periphery of the central through hole has eight locating holes, wherein the eight locating holes are evenly distributed in the circular arc that is concentric with the central through hole; between the central through hole and the locating hole has two slots, wherein the slots are central symmetric and between both ends of the two slots has locating hole;
an adapter, wherein one end is moveably connected with the permanent joint while the other end is fixedly connected with the gland; the connecting end of the permanent joint has a locating convexity in coordination with the eight locating holes of the permanent joint and a whirling limited post in coordination with the slot, while the end face has multistep central through hole to locate the reset spring;
a reset spring is placed inside the multistep central through hole of the adapter;
a connector, wherein one end has a spring button and the other end has a spring plate, while the connector pass through the reset spring and lock joint inside the through hole of the end face of the permanent joint by the central through hole of the adapter.
a gland, wherein one end of the gland is fixedly connected with the adapter and the other end has lamp binding post.
